(19) United States
(12) Patent Application Publication
(10) Pub. No.: US 2025/0270860 A1
(43) Pub. Date: Aug. 28, 2025

(54) VEHICLE DOOR HANDLE ASSEMBLY

(71) Applicant: Minebea AccessSolutions France, Alfortville (FR)

(72) Inventors: Marvin GINIES, Alfortville (FR); Bruno VILOTTA, Alfortville (FR)

(73) Assignee: Minebea AccessSolutions France, Alfortville (FR)

(21) Appl. No.: 19/062,125

(22) Filed: Feb. 25, 2025

(30) Foreign Application Priority Data
Feb. 28, 2024 (EP) 24315071.1

(51) Int. Cl. E05B 85/10; E05B 79/06

(52) U.S. Cl. CPC E05B 85/103; E05B 79/06; E05B 85/107

(57) ABSTRACT

A vehicle door handle assembly includes a bracket fixed on an inner side of a door panel and a movable handle fastened to the bracket. The bracket includes first and second levers respectively having first and second holes for receiving first and second axes. The movable handle includes first and second sleeves respectively with first and second recesses to receive the first and second levers and the first and second axes. The second recess includes a top oblong opening. The second axis has a non-circular flange arranged at a first end to be introduced in the top oblong opening and to be restrained axially by a top wall of the second recess. The second axis also includes a non-circular removable cap to be fastened to a second end of the second axis to prevent axial rotation of the second axis with respect to the second recess.

### TECHNICAL FIELD

The present invention relates to the field of vehicle door handles to control the opening of vehicle doors and in particular to retractable vehicle door handles configured for moving from a retractable position wherein the handle flushes with the outer side of the door panel to reduce drag when the vehicle is moving and a deployed position wherein the handle can be grabbed by a user to open the door.

### BACKGROUND OF THE INVENTION

The vehicle door handle assembly usually comprise a bracket fixed to the inner side of the vehicle door panel and a retractable or movable handle which is configured to be fastened to the bracket. The movable handle is configured to be displaced between a retractable position where it flushes with the outer side of the door panel and a deployed position where it can be grabbed by the user. The handle may then be rotated by a pulling of the user to open the door.

The handle may be fastened to the bracket and then the bracket is fixed to the door panel but in some cases, for technical reasons, the bracket is fixed to the door panel and the door handle is then fastened to the bracket. The handle comprises a structure comprising the technical parts of the handle such as the fastening means of the handle to the bracket and a cover configured to be fastened to the structure to provide the desired aesthetic appearance. In general, the cover is used to cover the fastening means of the handle and is therefore positioned last.

However, for handles enclosing electronic components, it may be necessary to assemble the cover to the structure of the handle before fastening the structure to the bracket, notably for potting the electronic components within the handle to provide an electrical insulation of the electronic components. Such potting cannot be done on the assembly line of the vehicle so that the structure and the cover have to be fastened together before being fastened to the bracket. In such cases, it becomes difficult to hide the technical parts of the structure while providing a correct functioning of the movable handle.

### SUMMARY OF THE INVENTION

It is therefore an aim of the present invention to provide a solution enabling fastening the complete handle, comprising the structure and the cover, to the bracket while providing a similar functioning and a smooth aspect for the user, in particular in the deployed position of the movable handle.

Thus, the present invention refers to a vehicle door handle assembly comprising:
a bracket configured to be fixed on an inner side of a door panel,
a movable handle fastened to the bracket and configured for moving between a retracted position wherein the movable handle flushes with an outer side of the door panel and a deployed position,
   wherein the bracket comprises a first lever comprising a first hole configured for receiving a first axis and a second lever comprising a second hole configured for receiving a second axis, the movable handle comprises a first sleeve with a first recess configured to receive the first lever and the first axis and a second sleeve with a second recess configured to receive the second lever and the second axis, the second recess being an oblong recess and comprising an opened top with a top oblong opening that has a narrower section than the oblong recess, the second axis comprising a non-circular flange arranged at a first end and configured to be introduced in the top oblong opening and to be restrained axially by a top wall of the second recess, the second axis also comprising a non-circular removable cap configured to be fastened to a second end of the second axis, opposite to the first end, the non-circular removable cap being configured to prevent the axial rotation of the second axis with respect to the second recess.

The use of a second axis comprising a first end with a non-circular flange and a second end configured for receiving a non-circular removable cap enables linking the second lever of the bracket and the movable handle so that the movable handle can rotate with respect to the second lever around the second axis and can translate with respect to the second lever thanks to the translation of the second axis along the oblong recess. Furthermore, such configuration enables positioning the second axis after the assembly of the cover on the structure of the movable handle.

According to another aspect of the present invention, the movable handle is configured for being rotated and translated with respect to the second lever.

According to another aspect of the present invention, the second end of the second axis comprises an indentation configured for receiving a screwdriver to enable the axial rotation of the second axis.

According to another aspect of the present invention, the non-circular removable cap comprises a sharp shape to break possible ice located in a bottom oblong opening in case of translation of the second axis in the second recess.

According to another aspect of the present invention, the non-circular removable cap is configured to be clipped on the second end of the second axis.

According to another aspect of the present invention, the first axis and the second axis are configured to be introduced from the bottom side of the movable handle when the movable handle is mounted on the vehicle. Preferably, the first axis and the second axis are mounted from the side that is not visible to a user, when the user is pulling on the handle. For example, the visible area can also be the bottom side and the top side the non-visible area, for example on a truck. In this example, the first axis and the second axis can be inserted from the top.

According to another aspect of the present invention, the movable handle comprises a structure comprising a third recess configured for receiving electronic components and a cover configured to be fastened to the structure and to cover the third recess comprising the electronic components.

The present invention also refers to a method for assembling a vehicle door handle assembly as described previously on a door panel, the door panel comprising an opening, the method comprises the following steps:
fixing the bracket on an inner side of the door panel, for example with screws,
positioning the first lever and the second lever in a deployed position,
positioning the movable handle so that the first sleeve comes around the first lever and the second sleeve comes around the second lever,
introducing the first axis in the first hole of the first lever and crimping the first axis,
introducing the second axis in the second hole of the second lever so that the first end of the second axis is introduced through the top oblong opening,
rotating the second axis in order for the non-circular flange to be restrained by a top wall of the second recess and,
clipping the non-circular removable cap to the second end of the second axis to prevent the axial rotation of the second axis with respect to the second recess.

According to another aspect of the present invention, the method also comprises the following steps after the fixation of the bracket:
positioning the electronic components in a third recess of the handle's structure,
fastening a cover to the handle's structure.

### BRIEF DESCRIPTION OF THE DRAWINGS

FIG. 1 is a perspective view of a bracket of a vehicle door handle assembly according to an embodiment of the present invention;

FIG. 2 is a perspective view of a door handle according to an embodiment of the present invention;

FIG. 3 is a perspective view of the top side of a structure of a door handle according to an embodiment of the present invention;

FIG. 4 is a perspective and cut view of a part of a door handle, a part of a lever of a bracket and an axis according to an embodiment of the present invention;

FIG. 5 is a perspective view of an axis according to an embodiment of the present invention;

FIG. 6 is a top view of the axis of FIG. 5;

FIG. 7 is a bottom view of the axis of FIG. 5;

FIG. 8 is a perspective and cut view of an axis positioned in a door handle assembly according to an embodiment of the present invention;

FIG. 9 is a top view of the axis of FIG. 8 when the axis is in a first position;

FIG. 10 is a top view of the axis of FIG. 8 when the axis is in a second position;

FIG. 11 is a bottom view of the axis of FIG. 5;

FIG. 12 is a side view of the second end of the axis of FIG. 5;

FIG. 13 is a bottom view of removal cap according to an embodiment of the present invention;

FIG. 14 is a cross section view of the removal cap of FIG. 13;

FIG. 15 is a perspective and cut view of an axis positioned in a door handle assembly according to an embodiment of the present invention;

FIG. 16 is the axis of FIG. 15 with the removal cap assembled to the axis.

FIG. 17 is a bottom view of the second axis assembled to the door handle;

FIG. 18 is a flowchart of the different steps of the present invention.

### DETAILED DESCRIPTION OF THE INVENTION

The following achievements are examples. Although, the specification refers to one or several embodiments, it does not imply that each reference refers to the same embodiment or that the features apply only to a single embodiment. Simple features of different embodiments can also be combined to provide other embodiments.

In the following of the description, the terms up, upper, low, lower, vertical, horizontal, bottom, top refers to relative positions or directions when the door handle is assembled to a vehicle.

The present invention refers to a vehicle door handle assembly 1 comprising a bracket 3 configured to be fixed on an inner side of a door panel and a movable handle 5 (shown in FIG. 2) and configured to be fastened to the bracket 3 and for moving between a retracted position wherein the handle 5 flushes with an outer side of the door panel and a deployed position.

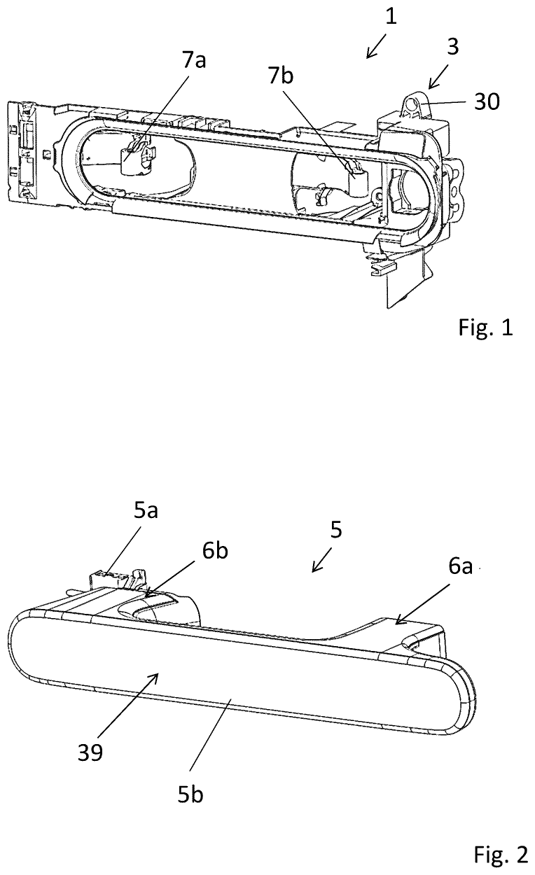

FIG. 1 represents a bracket 3 according to an embodiment of the present invention. The bracket 3 comprises a first lever 7a movable between a retracted position and a deployed position and a second lever 7b also movable between a retracted position and a deployed position. The first lever 7a comprises a first hole arranged at its end and configured for receiving a first axis and the second lever 7b comprises a second hole arranged at its end and configured for receiving a second axis 17.

FIG. 2 represents a movable handle 5 (gripping member) according to an embodiment of the present invention. The handle 5 comprises a structure 5a with the technical elements of the handle 5 and a cover 5b configured to be fastened to the structure 5a to hide the technical elements and provide a smooth aspect. The cover 5b may be made of plastic material. The structure 5a comprises a first sleeve 6a configured to be fastened to the first lever 7a of the bracket 3 and a second sleeve 6b configured to be fastened to the second lever 7b of the bracket 3.

The first sleeve 6a comprises a first recess configured to receive the end of the first lever 7a. The first recess may have a circular shape that is complementary with the end of the first lever 7a. The first recess comprises a through opening, herein called first opening, in the bottom wall of the recess. A blind hole may be arranged in the top wall of the recess to receive a first end of the first axis. The first axis may be inserted in the first hole of the first lever 7a via the first opening. The first axis may be crimped to be restrained axially in position. The first axis enables a rotation of the handle 5 with respect to the first lever 7a. The first axis may have a cylindrical shape.

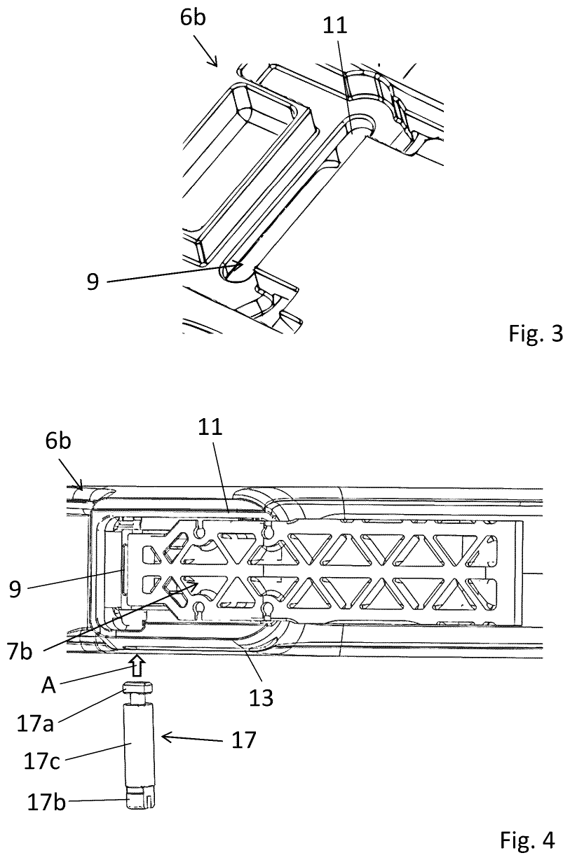

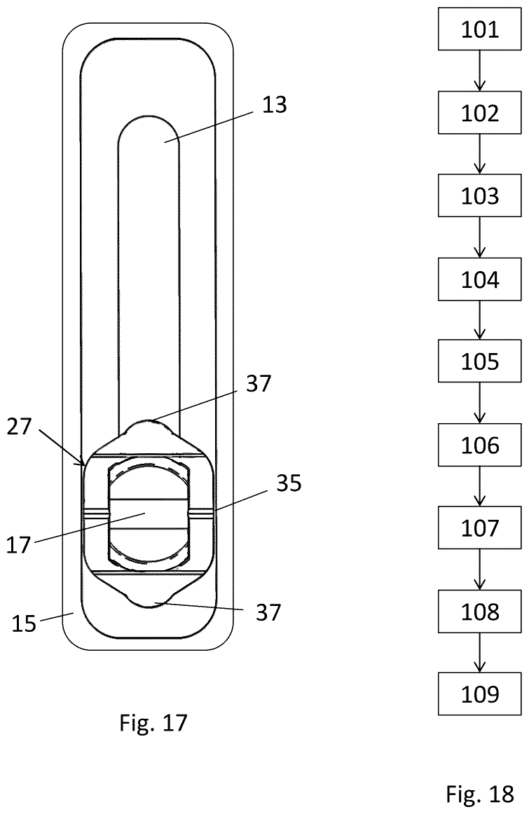

The second sleeve 6b comprises a second recess 9 (visible in FIG. 3 and FIG. 4) configured to receive the end of the second lever 7b. The second recess 9 has an oblong shape or oblong section so that the end of the second lever 7b may have different positions within the second recess 9. The second recess 9 comprises an opened top with a top oblong opening 11 that has a narrower section than the second recess 9. The second recess 9 also has an opened bottom with a bottom oblong opening 13 arranged in front of the top oblong opening 11. The bottom oblong opening 13 is wider than the top oblong opening 11 and comprises a flange 15 (visible in FIG. 17) surrounding the bottom oblong opening 13. The second axis 17 may be inserted in the second hole of the second lever 7a via the bottom oblong opening 13.

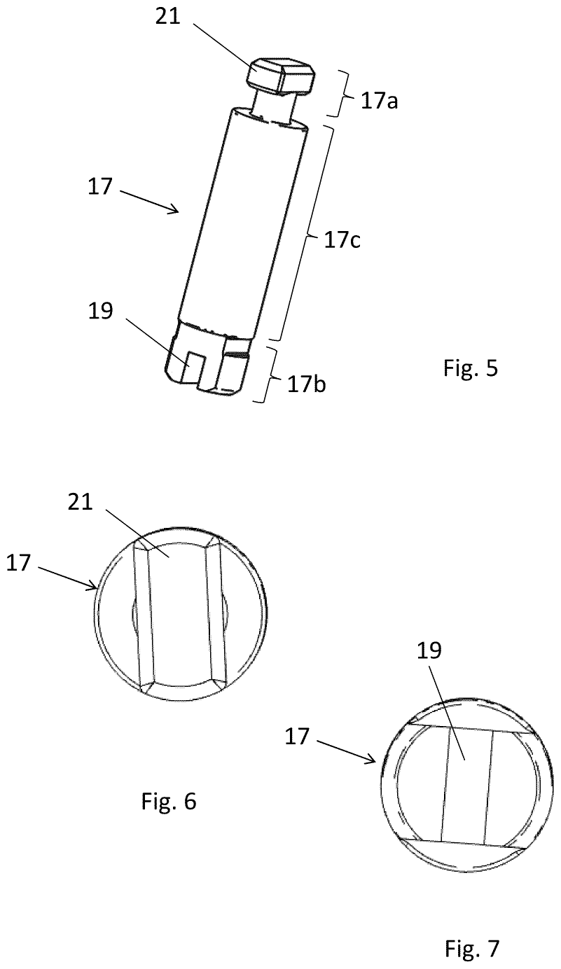

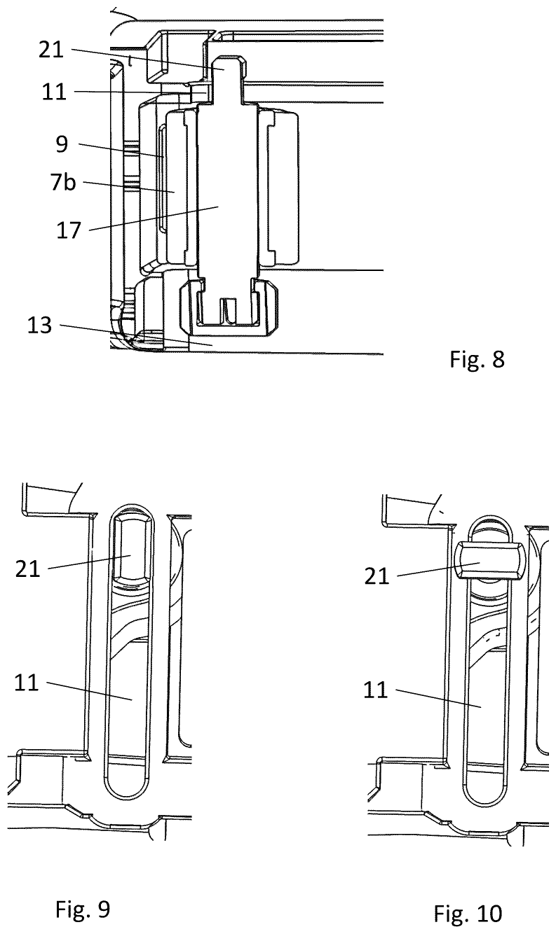

FIG. 5 represents an embodiment of the second axis 17. The second axis 17 comprises a first end 17a with a non-circular flange 21 as represented in the top view of FIG. 6, a second end 17b opposite to the first end 17a, that may comprise an indentation 19 configured for receiving a screwdriver as represented in the bottom view of FIG. 7 and a central part 17c that may have a cylindrical shape.

The non-circular flange 21 has a width which is smaller than the width of the top oblong opening 11 and a length which is larger than the width of the top oblong opening 11 such that the non-circular flange 21 can be introduced through the top oblong opening 11 when the non-circular flange 21 is oriented along the long side of the top oblong opening 11 as represented in FIG. 9 but the non-circular flange 21 cannot be removed from the top oblong opening 11 when it is oriented perpendicular to the long side of the top oblong opening 11 as represented in FIG. 10.

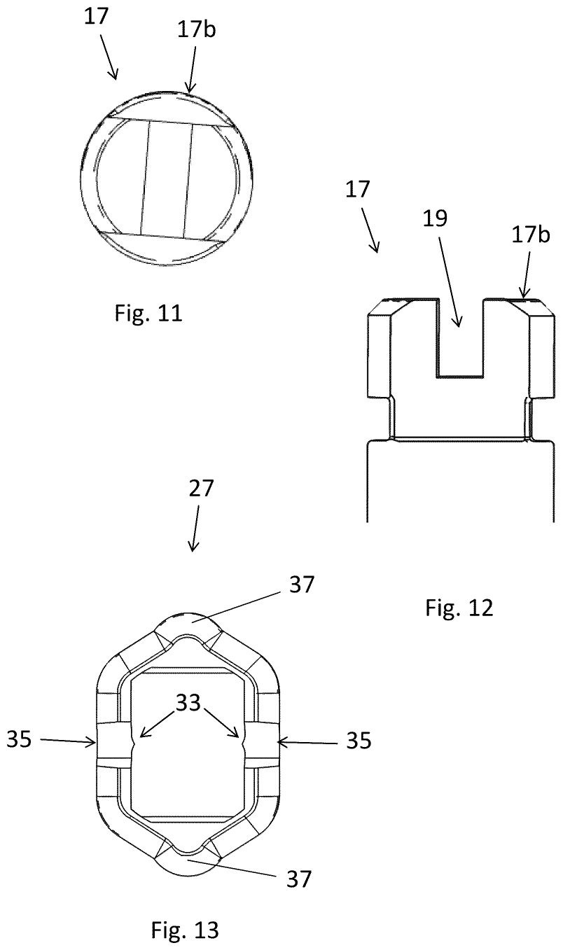

The second end 17b of the second axis 17 comprises two flat portions 23 as represented in FIG. 11 and two slots 25 as represented in FIG. 12.

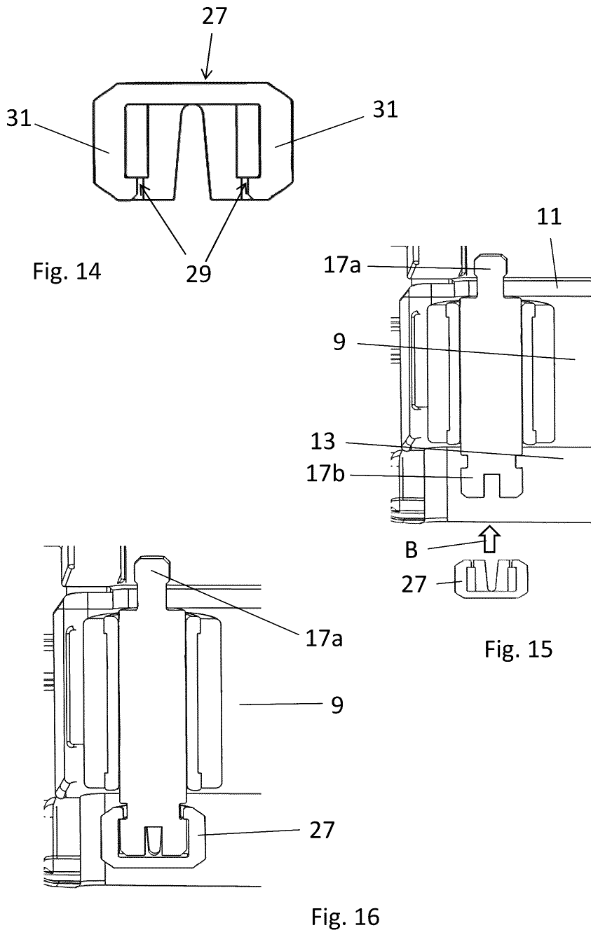

The second axis 17 also comprises a non-circular removal cap 27 configured to be fastened to the second end 17b of the second axis 17. The non-circular removal cap 27 may be clipped to the second end 17b. As represented in FIG. 14, the non-circular removal cap 27 may comprise two pins 29 arranged on two respective flexible arms 31 and configured to be introduced respectively in the two slots 25 to provide the clipping means. As represented in FIG. 13, the non-circular removal cap 27 also comprises two internal flat portions 33 configured to lie against the flat portions 23 of the second end 17b when the non-circular removal cap 27 is positioned on the second axis 17. The non-circular removal cap 27 also comprises two external flat portions 35 configured to lie against the flange 15 of the bottom oblong opening 13 as represented in FIG. 17. The non-circular removal cap 27 also comprises two sides with a sharp shape called sharp sides 37 to break possible ice located in the oblong recess in case of translation of the second axis 17 in the second recess 9.

The handle 5 may also comprises a third recess configured for receiving electronic components. The third recess may be arranged in the graspable lever 39 of the structure 5a. A potting may be applied around the electronic components, for example with resin, to protect the electronic components and to prevent electric contact with the conductive part of the structure 5a. The third recess may be closed by the cover 5b.

The cover 5b may cover the top part of the first sleeve 6a and the second sleeve 6b as represented in FIG. 2 but does not cover completely the bottom part of the first sleeve 6a and the second sleeve 6b in order to let the access to the bottom opening of the first recess and the bottom oblong opening 13 of the second recess 9 in order to introduce the first axis and the second axis 17.

Thus, the particular configuration of the vehicle door handle assembly 1 and in particular the second axis 17 and the second recess 9 enable the positioning of the second axis after the assembly of the cover 5b on the structure 5a while ensuring a rotation and a translation of the movable handle 5 with respect to the second lever 7b.

The present invention also refers to a method for assembling a vehicle door assembly 1 as described previously. FIG. 18 represents a flowchart of the different steps of the method.

The first step 101 refers to the fixation of the bracket 3 on an inner side of a door panel. The fixation may be achieved with screws. The bracket 3 may comprise a plurality of peripheral legs 30 with holes configured for receiving screws for the fixation of the bracket 3.

The second step 102 refers to the positioning of the electronic components in a third recess of the handle's structure. The second step may also refer to the potting of the electronic components with resin.

The third step 103 refers to the assembly or fastening of the cover 5b on the structure 5a. The cover 5b may be clipped and/or glued to the structure 5a.

The fourth step 104 refers to the positioning of the first lever 7a and the second lever 7b in a deployed position.

The fifth step 105 refers to the positioning of the movable handle 5 so that the first sleeve 6a and in particular the first recess comes around the first lever 7a and the second sleeve 6b and in particular the second recess 9 comes around the second lever 7b. The movable handle 5 is positioned so that the bottom opening of the first recess is in front of the first hole of the first lever 7a and so that the bottom oblong opening 13 of the second recess 9 is front of the second hole of the second lever 7b.

The sixth step 106 refers to the introduction of the first axis 7a in the first hole of the first lever 7a via the bottom opening of the first recess. The sixth step 106 may also comprise the crimping of the first axis in order to restrain axially the first axis in position. Such configuration enables a rotation of the movable handle 5 with respect to the first lever 7a. The rotation being achieved around the first axis.

The seventh step 107 refers to the introduction of the second axis 17 in the second hole of the second lever 7b via the bottom oblong opening 13 as represented by the arrow A in FIG. 4. The first end 17a of the second axis 17 is introduced first through the bottom oblong opening 13. The second axis 17 is inserted so that the first end 17a is inserted through the top oblong opening 11. The non-circular flange 21 is positioned along the long side of the top oblong opening to enable its insertion through the top oblong opening 11 as represented in FIG. 9.

The eighth step 108 refers to the rotation of the second axis 17, for example of 90°, in order for the non-circular flange 21 to be restrained by the top wall (located around the top oblong opening 13) of the second recess as represented in FIG. 10. The rotation may be achieved with a screwdriver positioned in the indentation 19 of the second end 17b of the second axis 17 The ninth step 109 refers to the clipping of the non-circular removable cap 27 to the second end 17b of the second axis 17 as represented by the arrow B in FIG. 15. The positioning of the non-circular removal cap 27 on the second end 17b of the second axis 17 as represented in FIG. 16 enable preventing the axial rotation of the second axis 17 with respect to the second recess. The second axis 17 is therefore restrained axially by the non-circular flange 21 of its first end 17a. The non-circular removal cap 27 prevents the rotation of the second axis 17 due, on one side, to its internal flat portions 33 that lie against the flat portions 23 of the first end 17a of the second axis 17 and, on the other side due to its external flat portions 35 that lie against the flange 15 of the bottom wall surrounding the bottom oblong opening 13.

Such configuration enables a rotation (around the second axis 17) and a translation (along the top 11 and bottom 13 oblong openings) of the movable handle 5 with respect to the second lever 7b. The rotation is enabled by the possible rotation of the second lever 7b with respect to the second axis 17 and the translation is enabled due to the possible translation of the second axis 17 along the top 11 and bottom 13 oblong openings.

Furthermore, such configuration enables positioning the second axis 17 after the assembly of the cover 5b to the structure 5a of the handle 5 and therefore the assembly of the movable handle 5 to the bracket 3 after the assembly of the cover 5b to the structure 5a of the handle 5 without degrading the functioning of the handle 5 and without degrading the aesthetic aspect of the handle 5 as the first and second 17 axis are introduced from the bottom side of the handle 5 so that the cover 5b can cover the top side of the first sleeve 6a and the second sleeve 6b of the structure 5a (as represented in FIG. 2).

The order of the different steps of the method described previously may be different, for example the second 102 and third 103 steps may be achieved before the first step 101. Some steps may be achieved simultaneously. Some steps may also be optional such as the second step.

1-9. (canceled)

10. A vehicle door handle assembly, comprising:
a bracket configured to be fixed on an inner side of a door panel; and
a movable handle fastened to the bracket and configured to move between a retracted position wherein the movable handle flushes with an outer side of the door panel and a deployed position,
wherein the bracket comprises a first lever comprising a first hole configured to receive a first axis and a second lever comprising a second hole configured to receive a second axis, the movable handle comprises a first sleeve with a first recess configured to receive the first lever and the first axis and a second sleeve with a second recess configured to receive the second lever and the second axis, the second recess being an oblong recess and comprising an opened top with a top oblong opening that has a narrower section than the oblong recess, the second axis comprising a non-circular flange arranged at a first end and configured to be introduced in the top oblong opening and to be restrained axially by a top wall of the second recess, the second axis also comprising a non-circular removable cap configured to be fastened to a second end of the second axis, opposite to the first end, the non-circular removable cap being configured to prevent the axial rotation of the second axis with respect to the second recess.

11. The vehicle door handle assembly in accordance with claim 10, wherein the movable handle is configured to be rotated and translated with respect to the second lever.

12. The vehicle door handle assembly in accordance with claim 10, wherein the second end of the second axis comprises an indentation configured to receive a screwdriver to enable the axial rotation of the second axis.

13. The vehicle door handle assembly in accordance with claim 10, wherein the non-circular removable cap comprises a sharp shape configured to break ice located in a bottom oblong opening in case of translation of the second axis in the second recess.

14. The vehicle door handle assembly in accordance with claim 10, wherein the non-circular removable cap is configured to be clipped on the second end of the second axis.

15. The vehicle door handle assembly in accordance with claim 10, wherein the first axis and the second axis are configured to be introduced from the bottom side of the movable handle when the movable handle is mounted on the vehicle.

16. The vehicle door handle assembly in accordance with claim 10, wherein the movable handle comprises a structure comprising a third recess configured to receive electronic components and a cover configured to be fastened to the structure and to cover the third recess comprising the electronic components.

17. A method for assembling the vehicle door handle assembly according to claim 10 on the door panel, the door panel comprising an opening, the method comprising:
fixing the bracket on the inner side of the door panel;
positioning the first lever and the second lever in the deployed position;
positioning the movable handle so that the first sleeve comes around the first lever and the second sleeve comes around the second lever;
introducing the first axis in the first hole of the first lever and crimping the first axis;
introducing the second axis in the second hole of the second lever so that the first end of the second axis is introduced through the top oblong opening;
rotating the second axis in order for the non-circular flange to be restrained by the top wall of the second recess; and
clipping the non-circular removable cap to the second end of the second axis to prevent the axial rotation of the second axis with respect to the second recess.

18. The method for assembling the vehicle door handle assembly according to claim 17, further comprising, after the fixing the bracket:
positioning electronic components in a third recess of a structure of the movable handle; and
fastening a cover to the structure of the movable handle.
